(19) United States
(12) Patent Application Publication
(10) Pub. No.: US 2007/0080814 A1
(43) Pub. Date: Apr. 12, 2007

(54) Dynamo operated portable device having an alert radio

(75) Inventors: Kevin Ellsworth, Hollywood, FL (US); Michael Krieger, Miami Beach, FL (US)

Correspondence Address: VENABLE LLP, P.O. BOX 34385, WASHINGTON, DC, 20043-9998, US

(73) Assignee: Vector Products, Inc., Ft. Lauderdale, FL (US)

(21) Appl. No.: 11/518,462

(22) Filed: Sep. 11, 2006

Related U.S. Application Data
(60) Provisional application No. 60/715,150, filed on Sep. 9, 2005.

(51) Int. Cl. G08B 23/00

(52) U.S. Cl. 340/573.1

(57) ABSTRACT

A battery powered portable device comprises an alert radio for receiving an alert broadcast signal. The portable device further includes a battery compartment for one or more rechargeable batteries that power the alert radio. A dynamo electrically coupled to the battery compartment of the portable device charges the one or more batteries, where the dynamo includes a hand crank that generates battery charge energy when rotated.

### BACKGROUND

A dynamo uses electromagnetic principles to convert mechanical rotation into an alternating electric current. Dynamos were amongst the early electrical generators capable of delivering power for industrywide applications. More recently, dynamos have been used in smaller scales for generating power in portable electronic devices. For example, US Patent Application Publication No. US 2004/0204180 closes a dynamo used for providing charge energy for the battery of a portable cell phone.

Known battery powered radio receivers have been used to receive weather alert and information. One such radio is an alert radio equipped to operate on National Oceanic and Atmospheric Administration's (NOAA) channels for reception of local public alert and weather reports, as well as bulletins for severe weather and hazardous conditions (i.e., fires, toxic chemical spills, earthquakes, radiation leaks, civil emergencies, acts of war, etc). One such radio automatically turns on when NOAA broadcasts an alert warning signal under severe weather or other types of hazardous situation to activate an alert siren and weather broadcast radio, while displaying an alert bulletin.

Also known are two-war radios or “walkie-talkies” that provide Family Radio Service (FRS), a Citizens Band Radio Service. FRS is used by family, friends and associates to communicate within a short distance, e.g., a neighborhood, within a communications range of less than a mile. The General Mobile Radio Service (GMRS) is also known as a land-mobile radio service available for short-distance two-way communications to facilitate the activities of an adult individual and his or her immediate family members. Some manufacturers have received approval to market radios that are FCC certified for use in both the FRS and GMRS. Other manufacturers have received approval of their radios under the GMRS rules, but market them as FRS/GMRS radios. Radios marketed as “FRS/GMRS” or “dual-service radios” are available from such manufacturers as Motorola Inc.

Due to battery current drain, a portable device that incorporates alert features in remote areas, e.g., high seas, may not have sufficient operational life to accommodate emergency situations. Therefore, there exists a need for a battery powered portable device with a simple and effective feature that prolongs its operational life.

### SUMMARY OF THE INVENTION

Briefly, according to the present invention, a battery powered portable device comprises an alert radio for receiving an alert broadcast signal. The portable device further includes a battery compartment for one or more rechargeable batteries that power the alert radio. A dynamo electrically coupled to the battery compartment of the portable device charges the one or more batteries, where the dynamo includes a hand crank that generates battery charge energy when rotated.

According to one of the more detailed features of the present invention, the portable device includes a radio receiver and a transmitter that provide a short distance radio service, such as a FRS service or GMRS. According to another more detailed feature of the present invention, the portable device includes a flash light, such as an LED flash light, powered by the one or more rechargeable batteries to provide lighting.

### DETAILED DESCRIPTION OF THE INVENTION

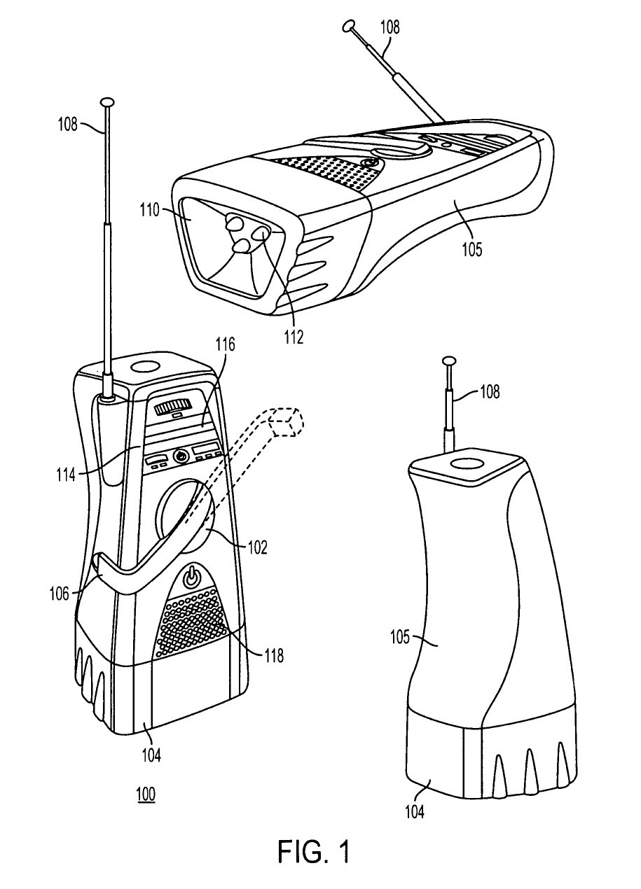

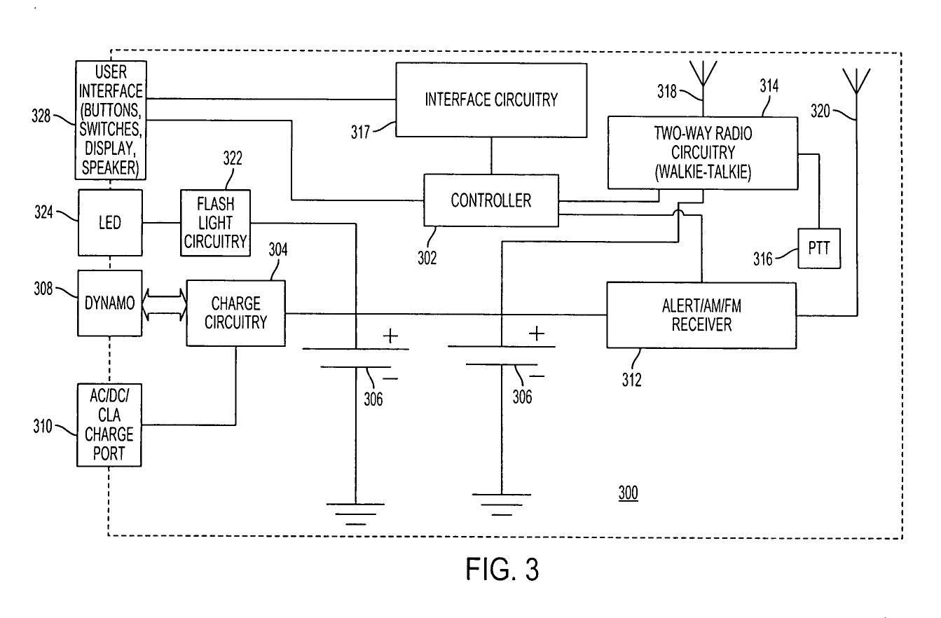

FIG. 1 shows multiple perspective views of a portable device 100 according to one exemplary embodiment of the present. The portable device 100 is a battery operated alert radio, powered by one or more rechargeable batteries (shown in FIG. 3). A dynamo 102 electrically couples to a battery compartment 104 disposed within the housing 105 of the device 100 for charging the one or more rechargeable batteries housed therein. The dynamo 102 includes a hand crank 106 that generates the charge energy when a user rotates the hand crank.

The one or more batteries of the portable device 100 power various circuits that provide multiple functionalities, as shown in FIG. 3. One such functionality is an alert radio functionality that receives broadcasts of alert signals from designated local, national or international entities, such as NOAA. As an alert radio, the portable device of the present invention can operate on any suitable broadcast band or channel designated by such entities to provide information, reports, audio or visual, bulletins, etc., for weather or any emergency or non-emergency situation. The portable device 100 includes an antenna 108 that couples the received broadcast alert signal to an internal radio receiver (shown in FIG. 3) that is tuned to the broadcast channel. Optionally, the radio receiver can also be tuned to commercial broadcast channels on the FM or AM bands.

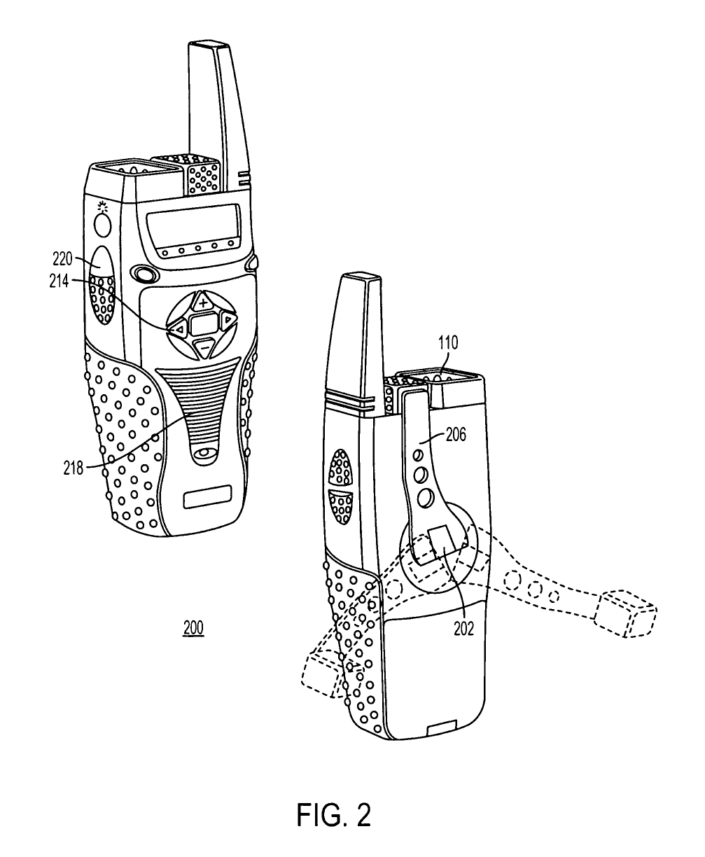

Referring to FIG. 2, another embodiment of the portable device 200 of present invention incorporates the functionality of FRS, GMRS, or both. These services comprise a two-way radio service with transmission and reception capabilities for short distances, e.g., less than a mile. The portable device 200 is a battery operated alert radio/walkie-talkie two-way radio, which, in addition to the FRS/GMRS, also incorporates alert and weather band radio functionalities as well AM/FM reception described in connection with portable device 100 of FIG. 1. Similarly, the portable device 200 is powered by one or more rechargeable batteries via an electrically coupled dynamo 202 that includes a hand crank for generating battery charge energy upon rotation of the hand crank 206.

According to another embodiment of the invention, the alert radio also includes an integrated flash light 110, which is powered by the one or more batteries. In the exemplary embodiments shown in FIGS. 1 and 2, the flash light 110 utilizes three LEDs 112 to provide lighting. The housings 105 and 205 of the portable devices 100 and 200 can be splash resistant for example, with a JIS4 rating. The portable device of the present invention can also include a belt clip (not shown) for ease of transportation and handling.

The portable device of the present invention includes suitable user interfaces that allow the user to properly operate the device with ease and convenience. Such user interface can include one or more buttons or switches 114 and 214 for setting the reception and/or transmission channels, e.g., weather, FM/AM, or FRS/GMRS channels. The user interfaces can also include display devices 116 and 216 for displaying images, text, video, etc., to the user, as necessary. For example, one of the display devices can be used to display channel settings of the radio, mapping images, video reports or broadcast text. Another user interface comprises one or more speakers 118 and 218 that provide audio alerts, sirens, reports or other type of audio broadcast, e.g., commercial programming, music, news, etc., on the appropriate channel settings of the portable device. Also, a push-to-talk (PTT) button 220 is used to activate the “walkie-talkie” functionality of FRS/GMRS services. When the PTT button 220 is activated an LED indicates a transmit operating mode. Otherwise, the device operates in a receive mode.

FIG. 3 shows a block diagram 300 of the portable device of the present invention. As shown, the portable device includes a controller 302 that is programmed in a well known manner to control the various functionalities of the device including, functionalities related to user interface. A charge circuit 304 provides charge energy to the one or more batteries 306 via a dynamo 308, when cranked. Also, the portable device may receive charge power from an AC or DC power source through a suitable port 310. One such DC power source can be a cigarette lighter adapter (CLA) that provides power via a vehicle battery, such as a boat or a car. The batteries power an alert radio receiver 312 that receives alert broadcast signals, such as weather as well as emergency or non-emergency alerts. As described above, the radio receiver 312 can also be tuned to receive commercial broadcasts on AM or FM channels. In another embodiment, the portable device can also includes a two-way radio powered 314 by the batteries 306, which is activated by a PTT switch 316 to operate in a receive mode or a transmit mode for providing short distance communication services, such as FRS or GMRS. One or more antennas 318 and 320 provide for reception and transmission of radio signals to and from the portable device. Although FIG. 3 shows separate antennas 318 and 320 for the two-way radio functionality and AM/FM radio functionality, a single antenna with proper switching function can be employed to provide for integrated reception and/or transmission of radio signals.

A battery powered flash light circuit 322 coupled to one or more LEDs 324 provides integrated lighting functionality for the portable device. All user interface functionalities are provided via an interface circuit 317, which receives input from the user via various interfaces, e.g., switches and buttons, and provides out put to the user, for example, via a display or speaker 328.

It will be appreciated that the potable device of the present invention provides a compact arrangement for various integrated functionalities, such as alert and two-way radio functionalities as well as lighting, where the one or more batteries that powers the portable device can be charged, particularly in emergency situations, by a dynamo.

1. A battery powered portable radio, comprising:
an alert radio for receiving an alert broadcast signal;
a battery compartment for housing one or more rechargeable batteries that power the alert radio;
a dynamo electrically coupled to the battery compartment for charging the one or more batteries, said dynamo including a crank that generates charge energy when rotated.

2. The portable device of claim 1 further comprising a flash light powered by the one or more rechargeable batteries to provide lighting.

3. The portable display device of claim 1, wherein the flash light comprises a light emitting diode (LED) flash light.

4. The portable device of claim 1 further comprising a radio receiver and a radio transmitter that provide a short distance radio service.

5. The portable device of claim 1, wherein the short distance radio service comprises at least one of an FRS service or GMRS service.
